(19) United States
(12) Patent Application Publication
(10) Pub. No.: US 2019/0074621 A1
(43) Pub. Date: Mar. 7, 2019

(54) CONNECTOR TERMINAL WIRE ROD AND CONNECTOR INCLUDING THE SAME

(71) Applicants: Sumitomo Electric Industries, Ltd., Osaka-shi (JP); Sumitomo Wiring Systems, Ltd., Yokkaichi (JP); AutoNetworks Technologies, Ltd., Yokkaichi (JP)

(72) Inventors: Mikio Sato, Itami-shi (JP); Hiromu Izumida, Itami-shi (JP)

(21) Appl. No.: 16/084,327

(22) PCT Filed: Dec. 21, 2016
(86) PCT No.: PCT/JP2016/088110

§ 371 Date: Sep. 12, 2018

(30) Foreign Application Priority Data
Apr. 13, 2016 (JP) 2016-080098

(51) Int. Cl. H01R 13/03; H01B 5/02; C25D 5/02; C25D 7/06; C25D 5/12

(52) U.S. Cl. CPC H01R 13/03; H01B 5/02; H01R 12/716; C25D 7/06; C25D 5/12; C25D 5/02

(57) ABSTRACT

Provided is a connector terminal wire rod including: a base material containing a metallic material; a first metallic layer formed to be exposed on the base material, the first metallic layer containing Sn; and a second metallic layer formed to be exposed on the base material, the second metallic layer containing Sn and Pd and being different from the first metallic layer in composition.

### TECHNICAL FIELD

The present disclosure relates to a connector terminal wire rod and a connector including the same.

The present application claims a priority based on Japanese Patent Application No. 2016-080098 filed on Apr. 13, 2016, the entire content of which is incorporated herein by reference.

### BACKGROUND ART

Various types of connectors, such as a connector for use with a printed circuit board (printed circuit board (PCB) connector), are each configured in such a way that its terminal is inserted into another connector to be fitted in a terminal in the latter connector, thus establishing electrical connection between the former connector and the latter connector. For the purpose of reducing the contact resistance between one connector terminal (so-called “male terminal”) and another connector terminal (so-called “female terminal”) to be fitted on the former terminal, forming a Sn (tin) plating layer on the terminal surface is known.

With the increase in the number of terminals disposed in a connector, an increased force is required to insert the terminals, which makes the insertion more difficult. Japanese Patent Laying-Open No. 2015-094000 (PTD 1) discloses reducing the terminal-insertion force by forming a Sn—Pd plating layer on the terminal surface, in place of a Sn plating layer.

### CITATION LIST

### Patent Document

PTD 1: Japanese Patent Laying-Open No. 2015-094000

### SUMMARY OF INVENTION

A connector terminal wire rod according to one embodiment of the present invention includes: a base material containing a metallic material; a first metallic layer formed to be exposed on the base material, the first metallic layer containing Sn; and a second metallic layer formed to be exposed on the base material, the second metallic layer containing Sn and Pd and being different from the first metallic layer in composition.

### BRIEF DESCRIPTION OF DRAWINGS

FIG. 1A is a schematic perspective view of a connector terminal wire rod according to one embodiment of the present invention.

FIG. 1B is a schematic cross-sectional view showing the Ib-Ib cross section in FIG. 1A.

FIG. 2A is a schematic perspective view showing a connector terminal wire rod according to another embodiment of the present invention.

FIG. 2B is a schematic side view showing a connector terminal wire rod according to another embodiment of the present invention.

FIG. 3 is a perspective view of a connector using a connector terminal wire rod.

FIG. 4 is a schematic cross-sectional view showing a state in which a connector according to an embodiment of the present invention is mounted on a substrate.

FIG. 5 is a schematic cross-sectional view showing a state in which a connector according to one embodiment of the present invention is connected to another connector that has a female terminal.

### DESCRIPTION OF EMBODIMENTS

### Problem to Be Solved by the Present Disclosure

As described above, in many of the connectors including a PCB connector, one end of its terminal is fitted in a terminal of another connector. The other end of the former terminal penetrates a through hole in a substrate and is electrically connected to a conductive layer disposed in the through hole via a solder. Since a Sn—Pd alloy is not high in solder wettability, the terminal having a Sn—Pd plating layer as described in PTD 1 may not be able to provide good electrical connection between the terminal and the conductive layer in the through hole.

An object of one embodiment of the present invention is to provide a connector terminal wire rod that has low contact resistance, enables reduction in insertion force, and is excellent in solder wettability; and to provide a connector including such a wire rod.

### Advantageous Effects of the Present Disclosure

According to one embodiment of the present invention, a connector terminal wire rod that has low contact resistance, enables reduction in insertion force, and is excellent in solder wettability; and a connector using such a connector terminal wire rod are provided.

### DESCRIPTION OF EMBODIMENTS OF THE PRESENT INVENTION

First, embodiments of the present invention are enumerated.

[1] A connector terminal wire rod including:
a base material containing a metallic material;
a first metallic layer formed to be exposed on the base material, the first metallic layer containing Sn; and
a second metallic layer formed to be exposed on the base material, the second metallic layer containing Sn and Pd and being different from the first metallic layer in composition.

The connector terminal wire rod having the above configuration has low contact resistance, enables reduction in insertion force, and is excellent in solder wettability.

[2] The connector terminal wire rod according to [1], where the connector terminal wire rod has a cross section in the shape of a quadrangle.

Such a connector terminal wire rod can form a conductive path by surface contact with a contact-point portion of a female terminal.

[3] The connector terminal wire rod according to [2], where, in cross section, at least one side of the quadrangle has the first metallic layer, and at least one of the other sides of the quadrangle has the second metallic layer.

Such a connector terminal wire rod can more satisfactorily achieve the effect of reducing the insertion force and the contact resistance.

[4] The connector terminal wire rod according to [2] or [3], where, in cross section, each of opposite two sides of the quadrangle has the second metallic layer.

Such a connector terminal wire rod can more satisfactorily reduce the insertion force and the contact resistance.

[5] The connector terminal wire rod according to any one of [1] to [4], where the Pd content in the second metallic layer is not less than 1.0% by mass and not more than 5.0% by mass.

Such a connector terminal wire rod allows for a metallographic structure where a Sn—Pd alloy phase is present in a Sn parent phase. This can satisfactorily reduce the contact resistance and the insertion force while ensuring high conductivity.

[6] The connector terminal wire rod according to any one of [1] to [5], further including a Ni layer between the base material and the second metallic layer.

Such a connector terminal wire rod can reduce metallic diffusion from the base material, and can reliably achieve a desired metallographic structure.

[7] The connector terminal wire rod according to any one of [1] to [6], where the first metallic layer has a thickness of not less than 0.5 μm and not more than 2.0 μm.

Such a connector terminal wire rod can ensure good conductivity without unnecessary increase in cost.

[8] The connector terminal wire rod according to any one of [1] to [7], where the second metallic layer has a thickness of not less than 0.5 μm and not more than 2.2 μm.

Such a connector terminal wire rod can satisfactorily reduce the insertion force without unnecessary increase in cost.

[9] The connector terminal wire rod according to any one of [1] to [8], where the connector terminal wire rod includes a narrow portion at an end thereof, the narrow portion having a reduced length in the direction substantially vertical to the longitudinal direction, the narrow portion including the first metallic layer and the second metallic layer.

Such a connector terminal wire rod can be easily inserted into another connector terminal (female terminal) or into a through hole when used as a connector terminal.

[10] A connector including the connector terminal wire rod according to any one of [1] to [9].

With such a connector terminal wire rod, a connector that has low contact resistance, enables reduction in insertion force, and is excellent in solder wettability can be provided.

### Details of Embodiments of the Present Invention

Embodiments of the present invention will now be described with reference to the drawings. Note that, however, that the embodiments described hereinafter are for the purpose of embodying the technical idea of the present invention and are not intended to restrict the technical scope of the present invention. A configuration described in one embodiment can be applied to another embodiment unless otherwise noted. In the description hereinafter, although terms that indicate specific directions and positions are used as needed (for example, “upper” and other terms containing this term), the use of such terms is merely for the purpose of easy understanding of the invention with reference to the drawings, and the technical scope of the present invention is not restricted by the meanings of such terms.

Note that the sizes, the positional relationships and the like of the members shown in the drawings may be exaggerated to make the explanation clear. The parts that are identically denoted in a plurality of figures indicate the same parts or members.

1. Connector Terminal Wire Rod

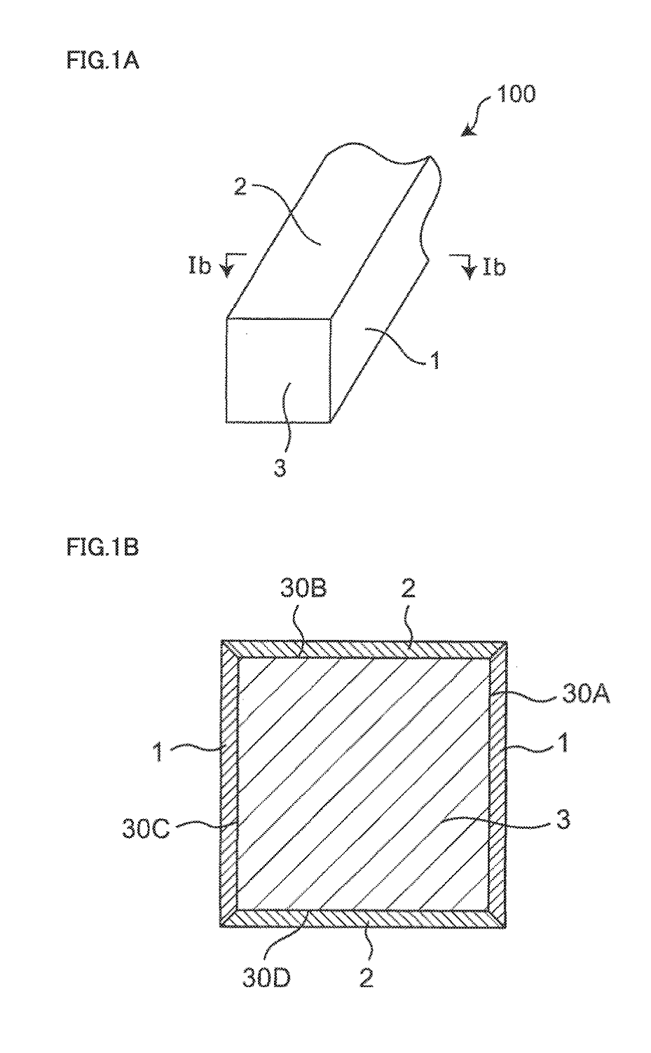

FIG. 1A is a schematic perspective view of a connector terminal wire rod 100 according to an embodiment of the present invention, and FIG. 1B is a schematic cross-sectional view showing the Ib-Ib cross section in FIG. 1A.

Connector terminal wire rod 100 includes a base material 3 containing a metallic material, a first metallic layer 1 formed to be exposed on base material 3, and a second metallic layer 2 formed to be exposed on base material 3.

The term “connector terminal wire rod” as used herein includes both a connector terminal wire rod before being cut to the length of one terminal to be disposed in a connector, and a connector terminal wire rod after being cut (and optionally provided with additional working after the cutting, and disposed in a connector).

The term “on base material 3” contained in the phrase “formed to be exposed on base material 3” includes not only a state of being in contact with base material 3, but also a state of not being in contact with base material 3 (such as a state in which another layer is interposed therebetween). The term “exposed” refers to a state in which the layer is formed at the surface (or on the outermost side) of connector terminal wire rod 100.

First metallic layer 1 contains Sn (tin). While second metallic layer 2 contains Pd (palladium) as described later, first metallic layer 1 does not substantially contain Pd. The term “does not substantially contain” refers to not intentionally adding Pd in an amount exceeding the impurity level. The term thus may be paraphrased as “does not contain Pd in an amount exceeding the impurity level”. Accordingly, second metallic layer 2 is different from first metallic layer 1 in composition. First metallic layer 1, which contains Sn but does not substantially contain Pd, is characterized by its excellent solder wettability.

First metallic layer 1 preferably has a thickness of not less than 0.5 μm and not more than 2.0 μm. A thickness of not less than 0.5 μm ensures good conductivity. A thickness of more than 2.0 μm may allow the effect to reach saturation, resulting in unnecessary increase in cost.

First metallic layer 1 is preferably made of Sn or a Sn alloy that contains Sn as a main component (not less than 50% by mass). Such first metallic layer 1 has better solder wettability.

Second metallic layer 2 contains Sn and Pd (palladium). Second metallic layer 2, which contains Pd in addition to Sn, allows insertion with a low insertion force at the time of fitting into a terminal of another connector. Further, a low contact resistance can be achieved.

Second metallic layer 2 preferably has a thickness of not less than 0.5 μm and not more than 2.2 μm. A thickness of not less than 0.5 μm can satisfactorily reduce the insertion force. A thickness of more than 2.2 μm may allow the effect to reach saturation, resulting in unnecessary increase in cost.

Second metallic layer 2 is preferably made of a Sn—Pd alloy. Second metallic layer 2 made of a Sn—Pd alloy can more satisfactorily reduce the insertion force. The Sn—Pd alloy is a concept including not only an alloy that consists of Sn, Pd, and inevitable impurities; but also an alloy that contains not more than 10% by mass of another alloy element for improving the properties.

If a Sn—Pd alloy is used as second metallic layer 2, the Pd content in the Sn—Pd alloy is preferably not less than 1.0% by mass and not more than 5.0% by mass. A Pd content of not less than 1.0% by mass and not more than 5.0% by mass enables the Sn—Pd alloy to have a metallographic structure where a Sn—Pd alloy phase is present in a Sn parent phase. This can more satisfactorily reduce the contact resistance and the insertion force while ensuring high conductivity.

The Pd content in the Sn—Pd alloy is more preferably not less than 3.5% by mass and not more than 4.5% by mass. This can further satisfactorily reduce the contact resistance and the insertion force while ensuring high conductivity.

Connector terminal wire rod 100 includes first metallic layer 1 and second metallic layer 2. When connector terminal wire rod 100 is used as a connector terminal, a terminal of another connector (a connector for receiving the terminal made of connector terminal wire rod 100) is fitted on the portion of the former connector terminal where second metallic layer 2 is formed at its one end. This can reduce the insertion force and the contact resistance.

When soldering the other end of the terminal, made of connector terminal wire rod 100, to a conductive layer in a through hole in substrate 41 for example, the solder is supplied to first metallic layer 1. Thus, excellent solder wettability can be obtained. This results in good electrical connection between the terminal and the conductive layer in the through hole.

The placement of first metallic layer 1 and second metallic layer 2 is described in detail hereinafter.

As described above, each of first metallic layer 1 and second metallic layer 2 is formed to be exposed on base material 3.

In the embodiment shown in FIG. 1B, base material 3 has four side faces 30A, 30B, 30C, and 30D; and has a cross section in the shape of a quadrangle. Connector terminal wire rod 100, which is obtained by forming first metallic layer 1 and second metallic layer 2 on the surfaces of base material 3, also has a cross section in the shape of a quadrangle.

On each of side face 30A (side 30A in cross section) and side face 30C (side 30C in cross section) opposite to side face 30A, first metallic layer 1 is formed in such a way as to cover them entirely. In other words, in cross section, first metallic layer 1 is formed on each of the opposite two sides 30A and 30C among the four sides of base material 3 over the entire length. First metallic layer 1 therefore has a large surface area, which enables easy soldering for electrical connection. The term “formed on . . . sides . . . over the entire length” as used herein is a concept that also includes a case in which a desired layer is inevitably not formed at a part of the sides or another layer is inevitably formed, depending on the masking conditions at the time of manufacture.

The placement of first metallic layer 1 is, however, not limited to the two sides as above. First metallic layer 1 may be formed on at least one side among the four sides of base material 3 in cross section. First metallic layer 1 may be formed, for example, on a part of at least one side. This provides high solder wettability to connector terminal wire rod 100.

In the embodiment shown in FIG. 1B, on each of side face 30B (side 30B in cross section) and side face 30D (side 30D in cross section) opposite to side face 30B, second metallic layer 2 is formed in such a way as to cover them entirely. In other words, in cross section, second metallic layer 2 is formed on each of the opposite two sides 30B and 30D among the four sides of base material 3 over the entire length. By placing second metallic layer 2 on each of the opposite sides in this way, a terminal, made of connector terminal wire rod 100, can be fitted in another connector terminal (female terminal) in such a way that these two sides 30B and 30D are held. This can more satisfactorily reduce the insertion force and the contact resistance. If second metallic layer 2 is disposed on each of two sides 30B and 30D, second metallic layer 2 may be disposed on at least a part of each of two sides 30B and 30D.

Such placement of second metallic layer 2 on the opposite two sides is preferred but not limitative. Second metallic layer 2 is simply required to be disposed on at least one side among the four sides of base material 3 in cross section. For example, second metallic layer 2 is simply required to be disposed on at least a part of one side. This can achieve the effect of reducing the insertion force and the contact resistance. Note that a side on which second metallic layer 2 is formed is preferably different from a side on which first metallic layer 1 is formed. This can more satisfactorily achieve the effect of reducing the insertion force and the contact resistance.

In the embodiment shown in FIG. 1B, all side faces of base material 3 are covered with either first metallic layer 1 or second metallic layer 2. This is, however, not limitative. Any one side face of the base material may include a part covered with neither first metallic layer 1 nor second metallic layer 2.

The quadrangular shape of a cross section of connector terminal wire rod 100 includes not only a square as shown in FIG. 1B, but also other quadrangles, such as a rectangle. Connector terminal wire rod 100 having a cross section in the shape of a quadrangle can form a conductive path by surface contact with a contact-point portion of a female terminal of another connector.

The cross sectional shape of connector terminal wire rod 100 is not limited to a quadrangle, but may be any other polygon.

In the embodiment shown in FIG. 1B, first metallic layer 1 is directly formed on a surface of base material 3. Alternatively, an intermediate layer may be formed between base material 3 and first metallic layer 1. A suitable example of such an intermediate layer is a Ni (nickel) layer. By forming a Ni layer on base material 3 and then forming first metallic layer 1 on the Ni layer, metallic diffusion from the base material can be reduced. Thus, first metallic layer 1 having desired properties (e.g. a desired metallographic structure) can reliably be obtained.

In the embodiment shown in FIG. 1B, second metallic layer 2 is also directly formed on a surface of base material 3. Alternatively, an intermediate layer may be formed between base material 3 and second metallic layer 2. A suitable example of such an intermediate layer is a Ni layer. By forming a Ni layer on base material 3 and then forming second metallic layer 2 on the Ni layer, metallic diffusion from the base material can be reduced. Thus, second metallic layer 2 having desired properties (e.g. a desired metallographic structure) can reliably be obtained.

Second metallic layer 2 may be formed on a layer that is substantially the same in composition as first metallic layer 1 (for example, a layer continuous with the exposed first metallic layer).

The Ni layer as used herein refers to a layer that contains not less than 50% by mass of Ni. A preferred Ni layer is made of metallic Ni or a Ni alloy. A suitable example of Ni alloy is a Ni—P alloy. For example, the Ni layer is preferably formed by plating, such as electrolytic Ni plating. This is because the plating can form a Ni layer excellent in adhesion at low cost. The Ni layer may be formed by a method other than plating, such as vapor deposition.

Base material 3 contains a metallic material. For example, base material 3 consists of a metallic material. The metallic material for base material 3 is preferably copper or a copper alloy which has high electrical conductivity. In order to ensure strength required as a terminal, a copper alloy is more preferably used. Examples of preferred copper alloy include brass and phosphor bronze.

2. Variation of Connector Terminal Wire Rod

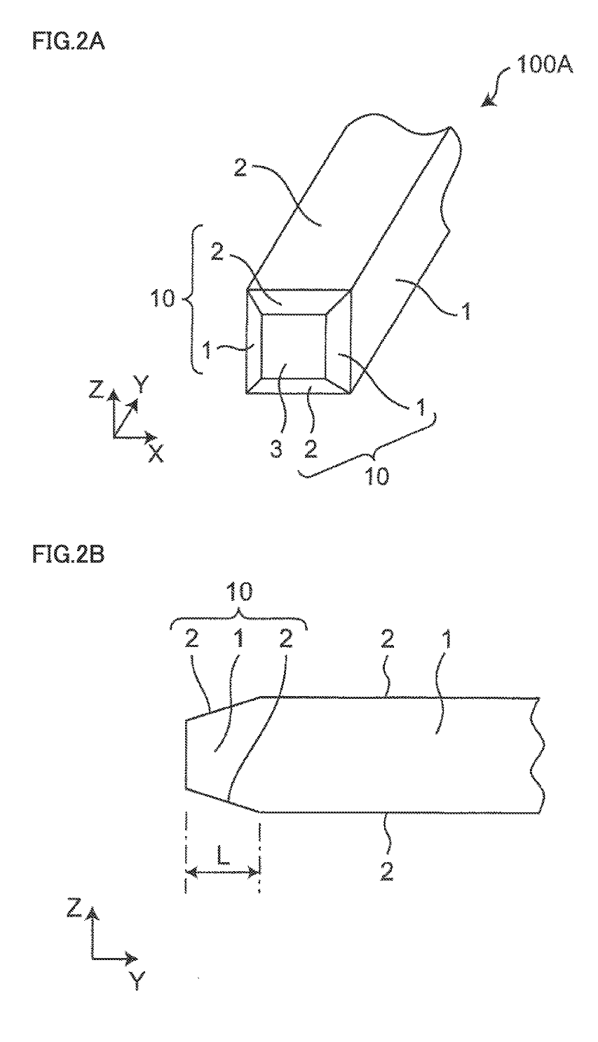

FIG. 2A is a schematic perspective view showing a connector terminal wire rod 100A according to another embodiment of the present embodiment, and FIG. 2B is a schematic side view showing connector terminal wire rod 100A.

Connector terminal wire rod 100A includes a narrow portion 10 at its end. Connector terminal wire rod 100A may be the same as connector terminal wire rod 100 in configuration except that the former has narrow portion 10.

Narrow portion 10 provided at an end of connector terminal wire rod 100A has a reduced length (width) compared with the other portion in the direction substantially vertical to the longitudinal direction (Y direction in FIG. 2). Here, the term “substantially vertical” means that the angle may be off the vertical direction to same extent (for example, by about 10°) when the length is evaluated, depending on the measurement conditions or the like. Preferably, the length is evaluated in the vertical direction. In the embodiment shown in FIG. 2, narrow portion 10 has a reduced length compared with the other portion (for example, a portion away from the narrow portion in the longitudinal direction) both in X direction and Z direction vertical to each other, among the directions substantially vertical to the longitudinal direction.

In the embodiment shown in FIG. 2A and FIG. 2B, narrow portion 10 has a length L in the longitudinal direction as shown in FIG. 2B. In length L, the length in the direction substantially vertical to the longitudinal direction becomes shorter toward the end.

This is, however, not limitative. The length may be reduced in only one of the two directions that are substantially vertical to the longitudinal direction and that are vertical to each other. For example, in FIG. 2A, the length in X direction may be reduced compared with the other portion, while the length in Z direction may be the same as that of the other portion.

In narrow portion 10, first metallic layer 1 and second metallic layer 2 are disposed on base material 3. Such connector terminal wire rod 100A including narrow portion 10 that has first metallic layer 1 and second metallic layer 2 thereon can be obtained by, for example, producing connector terminal wire rod 100 and then machining an end of connector terminal wire rod 100 with first metallic layer 1 and second metallic layer 2 unremoved. An example of such a machining method is pressing.

The use of connector terminal wire rod 100A that includes narrow portion 10 as a connector terminal is advantageous in that it can be easily inserted into another connector terminal or into a through hole.

In the embodiment shown in FIG. 2A and FIG. 2B as described above, the length in the direction substantially vertical to the longitudinal direction continuously decreases along the longitudinal direction. That is, the surface of each of first metallic layer 1 and second metallic layer 2 of narrow portion 10 is a flat surface or a gently curved surface.

Alternatively, the length of narrow portion 10 in the direction substantially vertical to the longitudinal direction may discontinuously decrease along the longitudinal direction. At least one of the surface of first metallic layer 1 and the surface of second metallic layer 2 of narrow portion 10 may be stepwise.

3. Method for Manufacturing Connector Terminal Wire Rod

A method for manufacturing connector terminal wire rod 100, 100A will now be described by way of example.

Base material 3 having a cross section in a predetermined shape, such as a quadrangle, is prepared. Base material 3 may be obtained by, for example, wiredrawing a base material that has a predetermined composition.

Next, a Sn layer is formed on a surface of base material 3 at the area for formation of first metallic layer 1. The formation of the Sn layer may be performed by Sn plating, such as electrolytic plating. That is, first metallic layer 1 may be a plating layer. Also, second metallic layer 2 may be a plating layer, such as a Pd layer formed by plating as described later. The Sn plating enables formation of a dense Sn layer at low cost.

The formation of the Sn layer, however, is not limited to plating, but may be performed by any other method applicable to formation of a Sn-containing layer, such as vapor deposition.

The formation of the Sn layer may be performed by continuous processing, such as so-called reel-to-reel processing, or may be performed by batch processing after base material 3 is cut into predetermined lengths.

Next, a Pd layer is formed on the area for formation of second metallic layer 2, and a Sn layer is formed on the Pd layer that has been formed. In order not to form the Pd layer on the Sn layer that has been formed at the area for formation of first metallic layer 1, a resin tape or the like may be applied for masking and a pretreatment for plating may be performed as needed before Pd plating such as electrolytic plating. The Pd plating enables formation of a dense Pd layer at low cost. On the Pd layer, a Sn layer may be formed in the same way as the Sn layer of first metallic layer 1. The formation of the Pd layer is not limited to plating, but may be performed by any other method applicable to formation of a Pd-containing layer, such as vapor deposition.

Instead of the above method, the formation of the Sn layers of first metallic layer 1 and second metallic layer 2 and the formation of the Pd layer of second metallic layer 2 may be performed by: first applying a resin tape or the like for masking in order not to form a Pd layer on the area for formation of first metallic layer 1; forming a Pd layer on the area for formation of second metallic layer 2; and then forming Sn layers on the areas for formation of first metallic layer 1 and second metallic layer 2. In forming second metallic layer 2, a Pd layer may be formed on a Sn layer, rather than forming a Sn layer on a Pd layer.

The formation of the Pd layer may be performed by continuous processing, such as so-called reel-to-reel processing, or may be performed by batch processing after base material 3 is cut into predetermined lengths.

Next, a heat treatment is performed so that Pd diffuses into Sn. Thus, second metallic layer 2 made of a Sn—Pd alloy can be obtained. It can be heated to a temperature of, for example, not less than 250° C. and not more than 400° C. in the heat treatment. Thus, connector terminal wire rod 100 can be obtained.

After connector terminal wire rod 100 is obtained, it may be cut to a piece, and a desired portion (e.g. an end) of the piece may be pressed, as needed. In this way, connector terminal wire rod 100A including narrow portion 10 can be obtained.

4. Connector

An example connector using connector terminal wire rod 100 or connector terminal wire rod 100A is described hereinafter.

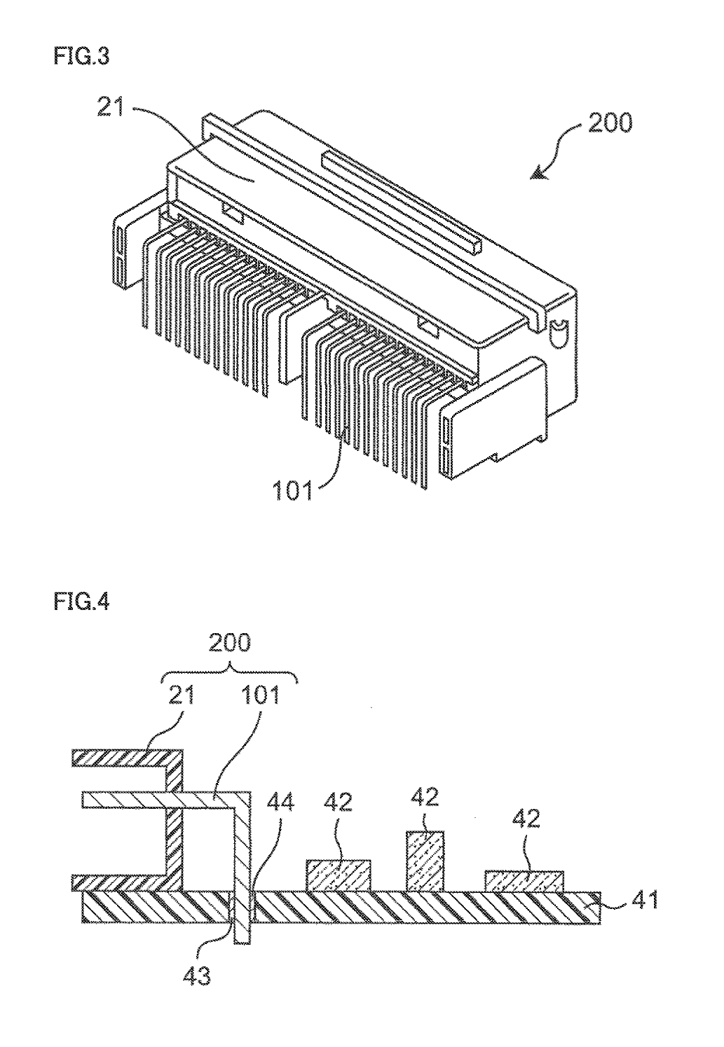

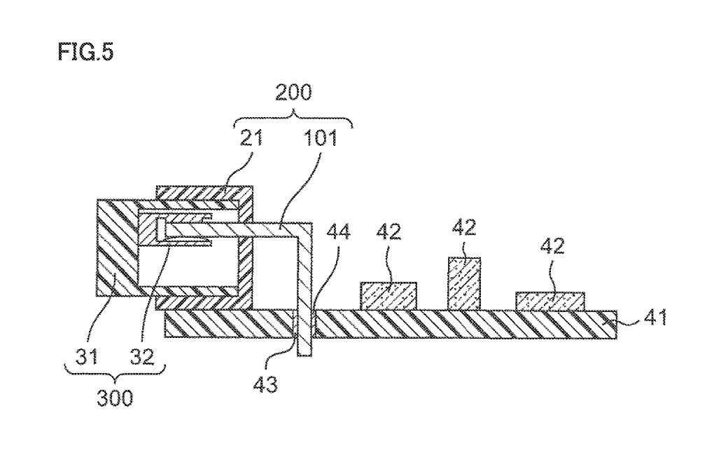

FIG. 3 is a perspective view of a connector 200 using connector terminal wire rod 100. FIG. 4 is a schematic cross-sectional view showing a state in which connector 200 is mounted on a substrate 41. FIG. 5 is a schematic cross-sectional view showing a state in which connector 200 mounted on substrate 41 is fitted in a connector 300 that has a female terminal 32.

Connector 200 includes a housing 21, and a terminal 101 obtained by cutting connector terminal wire rod 100 or connector terminal wire rod 100A into predetermined lengths. Housing 21 is made of a synthetic resin for example, and has one or more terminal insertion holes, with one end side of the terminal insertion hole being open, as shown in FIG. 4.

Terminal 101 includes a bent portion that is substantially 90° bent. Terminal 101 can consist of a horizontal portion extending in the horizontal direction and a vertical portion extending in the vertical direction, with the bent portion lying therebetween as a boundary. The bent portion of terminal 101 is located outside the housing, and the horizontal portion of terminal 101 extends from the bent portion through the side wall of housing 21, with an end of the horizontal portion being located in the hollow portion of housing 21.

As shown in FIG. 4, connector 200 can be mounted on substrate 41. Elements 42 are disposed on substrate 41 to be electrically connected to its wiring layer. Substrate 41 also has a through hole 44. Through hole 44 has a conductive layer on its inner wall surface, the conductive layer being electrically connected to the wiring layer.

On the surface of substrate 41, housing 21 of connector 200 is placed. The vertical portion of terminal 101 of connector 200 penetrates through hole 44, so that an end of the vertical portion of terminal 101 is located below the lower surface of substrate 41. Terminal 101 is electrically connected to the conductive layer of through hole 44 via a solder 43 in through hole 44. Since the first metallic layer of connector terminal wire rod 100 or connector terminal wire rod 100A used for terminal 101 has excellent solder wettability, good electrical connection can be established between terminal 101 and the conductive layer of through hole 44.

As shown in FIG. 5, the horizontal portion of terminal 101 is fitted in female terminal 32 of connector 300 that has entered the hollow portion of housing 21. Mating connector 300 includes a housing 31 and female terminal 32 made of a conductive material. Housing 31 is made of a resin for example, and supports female terminal 32. When housing 31 of mating connector 300 is inserted in the hollow portion of housing 21 of connector 200, female terminal 32 is fitted on an end of the horizontal portion of terminal 101. Thus, connector 200 and connector 300 are electrically connected.

Female terminal 32 is fitted on the second metallic layer of terminal 101. Thus, the fitting of female terminal 32 on terminal 101 can be performed with a low insertion force, with a low contact resistance between female terminal 32 and terminal 101.

The embodiments disclosed herein should be construed as being by way of illustration in every respect and not by way of limitation. The scope of the present invention is defined not by the above-described embodiments but by the claims. It is intended that the scope of the present invention encompasses any modification within the meaning and scope equivalent to the scope of the claims.

### REFERENCE SIGNS LIST

1: first metallic layer; 2: second metallic layer; 3: base material; 21, 31: housing; 32: female terminal; 41: substrate; 42: element; 43: solder; 44: through hole; 30A, 30B, 30C, 30D: side face of base material (side of base material in cross section); 100, 100A: connector terminal wire rod; 101: terminal; 200: connector; 300: another connector

1. A connector terminal wire rod comprising:
a base material containing a metallic material;
a first metallic layer formed to be exposed on the base material, the first metallic layer containing Sn; and
a second metallic layer formed to be exposed on the base material, the second metallic layer containing Sn and Pd and being different from the first metallic layer in composition.

2. The connector terminal wire rod according to claim 1, wherein the connector terminal wire rod has a cross section in a shape of a quadrangle.

3. The connector terminal wire rod according to claim 2, wherein, in cross section, at least one side of the quadrangle has the first metallic layer, and at least one of the other sides of the quadrangle has the second metallic layer.

4. The connector terminal wire rod according to claim 2, wherein, in cross section, each of opposite two sides of the quadrangle has the second metallic layer.

5. The connector terminal wire rod according to claim 1, wherein a Pd content in the second metallic layer is not less than 1.0% by mass and not more than 5.0% by mass.

6. The connector terminal wire rod according to claim 1, further comprising a Ni layer between the base material and the second metallic layer.

7. The connector terminal wire rod according to claim 1, wherein the first metallic layer has a thickness of not less than 0.5 μm and not more than 2.0 μm.

8. The connector terminal wire rod according to claim 1, wherein the second metallic layer has a thickness of not less than 0.5 μm and not more than 2.2 μm.

9. The connector terminal wire rod according to claim 1, wherein the connector terminal wire rod includes a narrow portion at an end thereof, the narrow portion having a reduced length in a direction substantially vertical to a longitudinal direction, the narrow portion including the first metallic layer and the second metallic layer.

10. A connector comprising the connector terminal wire rod according to claim 1.
